(19) United States
(12) Patent Application Publication
(10) Pub. No.: US 2005/0207750 A1
(43) Pub. Date: Sep. 22, 2005

(54) Image taking apparatus having a shutter block

(75) Inventor: Toshihiko Hirota, Osaka (JP)

Correspondence Address: BRINKS HOFER GILSON & LIONE, P.O. BOX 10395, CHICAGO, IL, 60610, US

(73) Assignee: Konica Minolta Photo Imaging, Inc.

(21) Appl. No.: 11/081,992

(22) Filed: Mar. 16, 2005

(30) Foreign Application Priority Data
Mar. 18, 2004 (JP) 2004-77616

(51) Int. Cl. G03B 17/00

(52) U.S. Cl. 396/541

(57) ABSTRACT

An image taking apparatus is provided with; an optical lens; an image sensor where a subject image formed by the optical lens is taken; and a shutter block situated between the optical lens and the image sensor, and has a shutter blade that is movable between a first position in which the taking luminous flux is intercepted within a plane orthogonal to the optical axis and a second position in which the taking luminous flux is transmitted. The shutter block is held so as to be insertable and detachable within the plane orthogonal to the optical axis.

This application is based on the application No. 2004-77616 filed in Japan, the contents of which are hereby incorporated by reference.

### BACKGROUND OF THE INVENTION

1. Field of the Invention

The present invention relates to an image taking apparatus using silver halide film, an image sensor or the like.

2. Description of the Related Art

Generally, the lives of cameras are affected by mechanical abrasions of the shutter mechanism that performs dynamic operations and the driving mechanism including a motor. For this reason, the shutter mechanism and the driving mechanism are frequently inspected and replaced. However, since the shutter mechanism and the driving mechanism are situated inside the camera, when they are detached, it is necessary to detach a large number of parts. In particular, when it is necessary to detach the mount for lens attachment in lens-interchangeable cameras, since the distance and the relative inclination between the mount and the image sensor or the like are changed to degrade the focus performance, readjustment and inspection are required. As mentioned above, the inspection and the replacement of the shutter mechanism and the driving mechanism are complicated, require a great deal of time, and hinder the reduction in the cost of the inspection and the examination.

The present invention is made in view of the above-mentioned conventional problem, and an object thereof is to provide an image taking apparatus in which the shutter mechanism and the driving mechanism can be easily inserted and detached with a lower cost.

### SUMMARY OF THE INVENTION

To attain the above-mentioned object an image taking apparatus according to the present invention comprising: an image taking lens; an image sensor for capturing a subject image by the image taking lens; and a shutter block that is situated between the optical lens and the image sensor and is movable between a first position in which a taking luminous flux from the lens is intercepted within a plane orthogonal to an optical axis of the lens and a second position in which the taking luminous flux from the lens is transmitted to the image sensor, wherein the shutter block is held so as to be insertable and detachable within the plane orthogonal to the optical axis.

According to the present invention, since the shutter block is insertable and detachable within the plane orthogonal to the optical axis, the shutter block can be easily inserted and detached with a lower cost.

In the following description, like parts are designated by like reference numbers throughout the several drawings.

### BRIEF DESCRIPTION OF THE DRAWINGS

FIG. 1 is a front view of a camera according to an embodiment of the present invention;

FIG. 2 is a lateral cross-sectional view of the camera of FIG. 1;

FIGS. 3(A) and 3(B) are longitudinal cross-sectional views of the camera of FIG. 1, FIG. 3(A) showing a mirror charging completion condition and FIG. 3(B) showing a mirror running completion condition;

FIGS. 4(A) and 4(B) are front views of a shutter body of the camera of FIG. 1, FIG. 4(A) showing a shutter charging completion condition and FIG. 4(B) showing a shutter running completion condition;

FIG. 5 is a-front view of a driving unit;

FIGS. 6(A) and 6(B) show the mirror charging completion condition, FIG. 6(A) being a front view of a mirror charger of the driving unit and FIG. 6(B) being a side view of a mirror driver;

FIGS. 7(A) and 7(B) show the mirror running completion condition, FIG. 7(A) being a front view of the mirror charger of the driving unit and FIG. 7(B) being a side view of the mirror driver;

FIGS. 8(A) and 8(B) are front views of a shutter charger of the driving unit, FIG. 8(A) showing the shutter charging completion condition and FIG. 8(B) showing the shutter running completion condition;

FIGS. 9(A) and 9(B) show the shutter charging completion condition, FIG. 9(A) being a front view of a shutter driver and FIG. 9(B) being a side view of the shutter driver;

FIGS. 10(A) and 10(B) show the shutter running completion condition, FIG. 10(A) being a front view of the shutter driver and FIG. 10(B) being a side view of the shutter driver;

FIG. 11 is a front view of the camera showing the insertion and detachment structure of the shutter unit and the driving unit;

FIG. 12(A) is a bottom view in a condition where the bottom lid of the camera is detached which view shows the insertion and detachment structure of the shutter unit and the driving unit;

FIG. 12(B) is a bottom view of the shutter unit and the driving unit detached from the camera body; and

FIGS. 13(A) and 13(B) are front views showing another embodiment of the shutter charger, FIG. 13(A) showing the shutter charging completion condition and FIG. 13(B) showing the shutter running completion condition.

### DETAILED DESCRIPTION OF THE PREFERRED EMBODIMENT

Hereinafter, an embodiment of the present invention will be described with reference to the drawings.

<General Arrangement Structure>

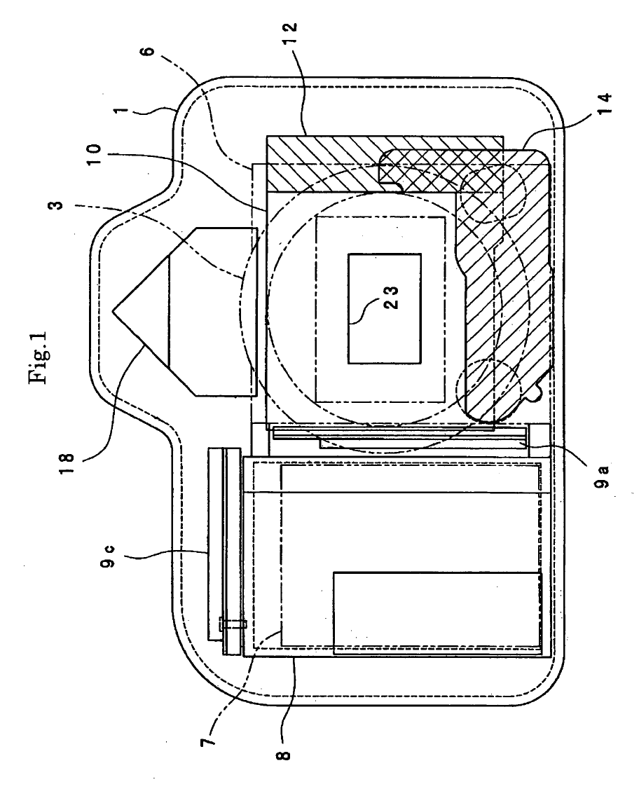

FIGS. 1 to 3 show a lens-interchangeable single-lens reflex digital camera having a focal-plane shutter which camera is an example of an image taking apparatus according to the embodiment of the present invention. First, the general arrangement structure of components of this camera will be described.

A circular opening 2 is formed on the front surface of the camera body 1, and an annular mount 3 for attaching a non-illustrated interchangeable lens is attached to the rim of the opening 2. The mount 3 restricts the interchangeable lens in the direction of the optical axis. The central axis of the mount 3 is the optical axis, and the taking optical path is formed along the optical path. A grip portion 4 comprising a convex portion 4a held by the user's right hand and a concave portion 4b in which the tip of a finger of the user's is fitted is formed on the front surface of the end portion on the left side, of the taking optical path, of the body 1 when viewed from the front. A hold portion 5 held by the user's left hand is formed on the right side, of the taking optical path, of the camera body 1 when viewed from the front.

A rectangular cross-section frame member 6 that is open at the front and rear ends is provided behind the mount 3 inside the camera body 1. The frame member 6 surrounds the taking optical path to prevent the incidence of harmful light and functions as a structure in the central part of the camera body.

A battery cavity 8 housing a battery 7 is disposed on the left side of the frame member 6. A first circuit board 9a is disposed between the battery cavity 8 and the frame member 6. Further, a second circuit board 9b and a third circuit board 9c are disposed behind and above the battery cavity 8, respectively.

A shutter body 10 is disposed behind the frame member 6, and an image sensor 11 which is a photoelectric conversion element is disposed behind the shutter body 10. A shutter driver 12 is disposed on the front surface of the extension, on the right side, of the shutter body 10 and on the right outside of the frame member 6. That is, the shutter driver 12 is disposed in the vicinity of the image sensing surface of the image sensor 11 and on the side, opposite to the grip portion 4, of the camera body 1 when viewed from the front. A mirror driver 13 is disposed between the shutter driver 12 and the frame member 6. A driving unit 14 that charges the shutter driver 12 and the mirror driver 13 and performs focus driving by driving the focusing lens unit movably provided in the non-illustrated interchangeable lens, in the direction of the optical axis at the time of focusing is disposed in an inverted L shape from forward of the shutter driver 12 to below the frame member 6.

A mirror 15 is disposed inside the frame member 6. An opening 16 is formed at the top of the frame member 6, a focusing screen 17 is disposed in the opening 16, and a pentagonal roof prism 18 is disposed above the focusing screen 17. An eyepiece optical system 19 and an eyepiece window 20 are provided behind the pentagonal roof prism 18. An opening 21 is also formed at the bottom of the frame member 6, and an AF module 22 is disposed below the opening 21.

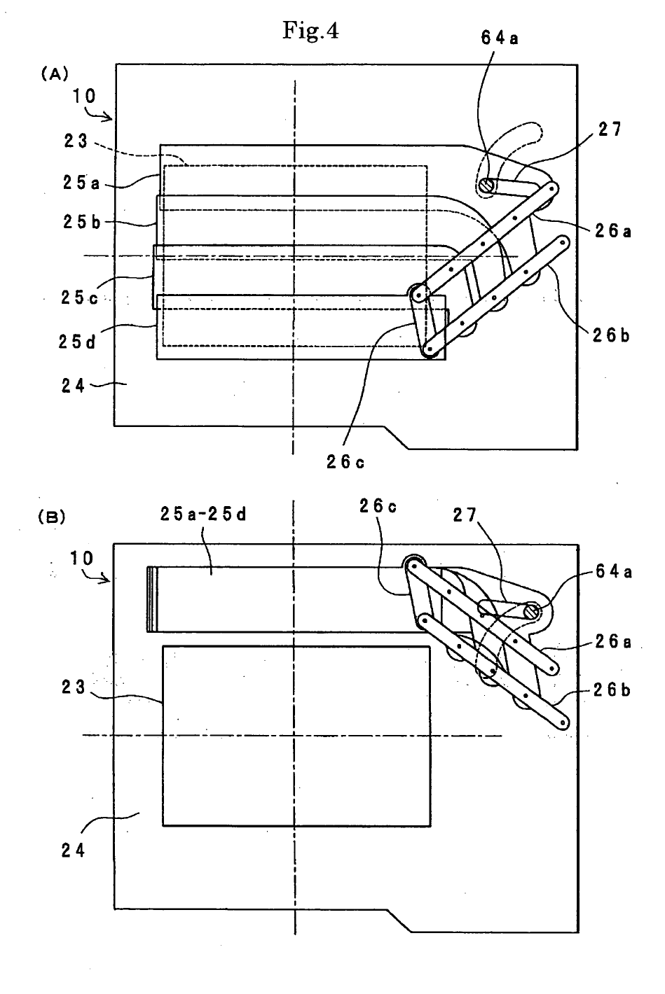

As shown in FIGS. 4(A) and 4(B), the shutter body 10 comprises a shutter base plate 24 in which a rectangular exposure window 23 is formed and a plurality of shutter blades 25a, 25b, 25c and 25d that open and close the exposure window 23 of the shutter base plate 24. One ends of the shutter blades 25a, 25b, 25c and 25d are attached to parallel link members 26a, 26b, 26c and 26d attached to the shutter base plate 24. A cam hole 27 is formed in the first shutter blade 25a, and a cam pin 64a of a shutter driving lever 64, described later, of the shutter driver 12 is slidably inserted in the cam hole 27. This structure enables the shutter blades 25a to 25d to move between a first position in which the taking luminous flux is intercepted by closing the exposure window 23 (charging completion condition where the charging of the shutter has been completed) and a second position in which the taking luminous flux is transmitted by opening the exposure window 23 (running completion condition where the shutter has completed running).

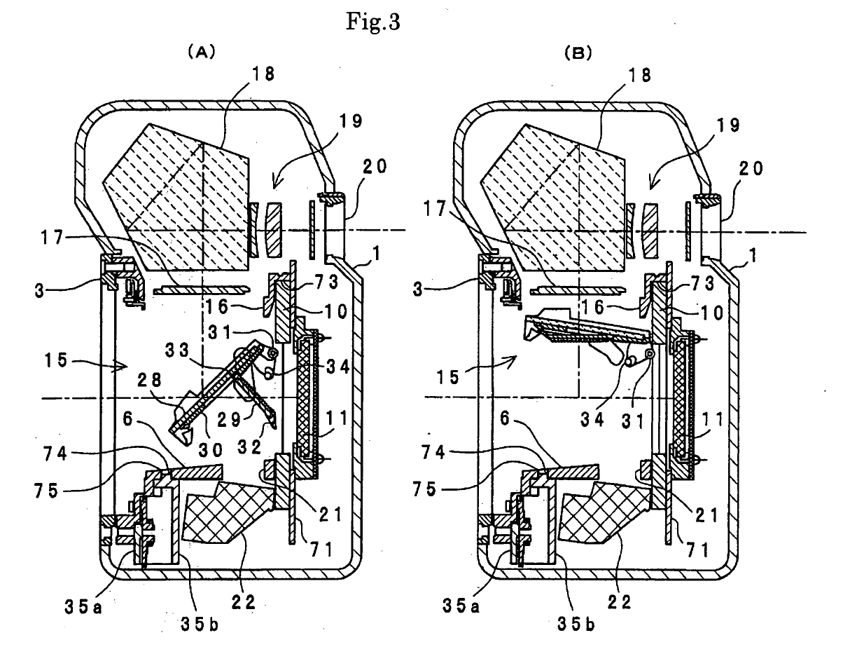

As shown in FIG. 3, the mirror 15 comprises a main mirror 28 and an auxiliary mirror 29. The main mirror 28 is held on a main mirror holder 30, and attached to the frame member 6 so as to be rotatable about the rotation axis 31 of the mirror holder 30. The auxiliary mirror 29 is held on an auxiliary mirror holder 32, and attached to the main mirror holder 30 so as to be rotatable about the rotation axis 33 of the auxiliary mirror holder 32. The auxiliary mirror 29 rotates relatively to the main mirror holder 30 with the rotation force of the main mirror holder 30 as the driving source. This structure enables the mirror 15 to move between a first position in which the main mirror 28 and the auxiliary mirror 29 are within the taking optical path and inclined with respect to the taking optical path so that the taking luminous flux is reflected as shown in FIG. 3(A) (charging completion condition where the charging to the mirror has been completed) and a second position in which the main mirror 28 and the auxiliary mirror 29 are retracted from the taking optical path so that the taking luminous flux is directed to the image sensor 11 as shown in FIG. 3(B) (running completion condition where the mirror has completed running). A driving shaft 34 is provided in the vicinity of the rotation axis 31 of the main mirror holder 30.

By this structure, the image passing through the non-illustrated interchangeable lens, reflected at the main mirror 28 and formed on the focusing screen 17 can be viewed through the eyepiece window 20 by way of the pentagonal roof prism 18 and the eyepiece optical system 19 when image taking is not performed in the charging completion condition of the mirror 15. On the other hand, since a part, in the vicinity of the center of the optical axis, of the main mirror 28 is formed as a half mirror, part of the light quantity having passed through the main mirror 28 is reflected downward at the auxiliary mirror 29 to be directed to the AF module 22 and the defocus amount is detected, whereby the focus adjustment of the lens can be performed by the driving unit 14. Moreover, in the running completion condition of the mirror 15, the mirror 15 is retracted from the taking optical path, and the exposure window 23 of the shutter body 10 is opened and the taking luminous flux is directed to the image sensor 11, whereby the taking luminous flux can be formed into an image and recorded.

While the above-described embodiment is a so-called digital camera using the image sensor 11, the present invention is also applicable to film-based cameras.

Next, the driving unit 14, the mirror driver 13 and the shutter driver 12 of the camera of the above-described embodiment will be described in detail.

<Driving Unit>

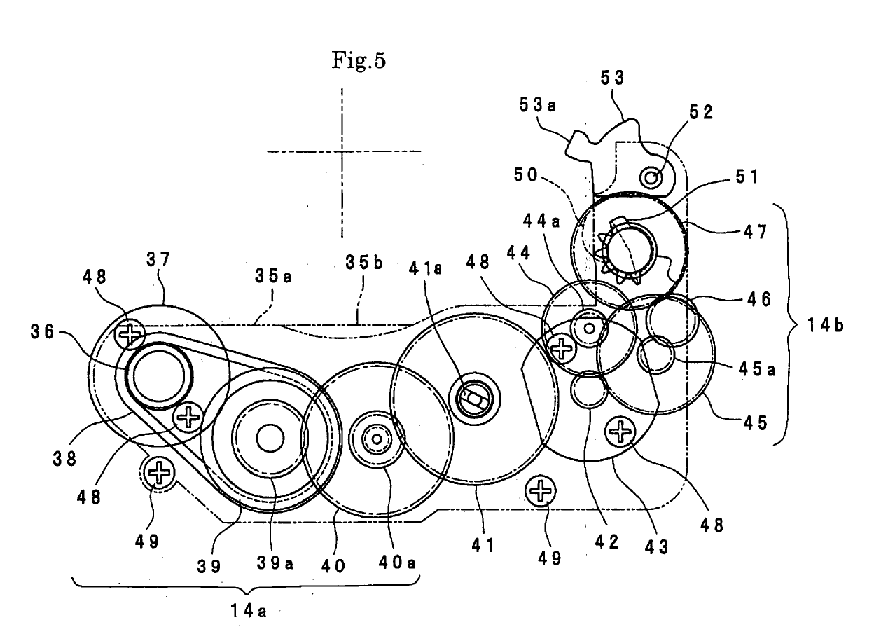

FIG. 5 shows the driving unit 14. The diving unit 14 comprises a focus driver 14a and a charger 14b. The focus driver 14a drives the focusing lens unit of the non-illustrated interchangeable lens. The charger 14b charges the mirror driver 13 to drive the main mirror 28 and the auxiliary mirror 29 from the second position outside the taking optical path to the first position within the taking optical path, and charges the shutter driver 12. The focus driver 14a and the charger 14b are mounted so as to be sandwiched in the direction of the optical axis between two inverted L-shaped driving plates 35a and 35b.

The focus driver 14a comprises: a focus motor 37 in which a driving pulley 36 is fixed to the driving shaft thereof; a driven pulley 39 coupled to the driving pulley 36 of the focus motor 37 through a belt 38; a first gear 40 meshing with a transmission gear 39a of the driven pulley 39; and a second gear 41 meshing with a transmission gear 40a of the first gear 40. By rotating the second gear 41, a key-shaped coupler 41a is rotated to be engaged with a coupler of the non-illustrated interchangeable lens, thereby driving the focusing lens.

The charger 14b comprises a charging motor 43 in which a driving gear 42 is fixed to the driving shaft; a third gear 44 meshing with the driving gear 42 of the charging motor 43; a fourth gear 45 meshing with a transmission gear 44a of the third gear 44; a fifth gear 46 meshing with a transmission gear 45a of the fourth gear 45; and a sixth gear 47 meshing with the fifth gear 46. The sixth gear 47 is driven counterclockwise in FIG. 5. The focus motor 37 and the charging motor 43 are fixed to the back surface of the driving plate 35b on the rear side by screws 48, and the other members are held between the two driving plates 35a and 35b. The two driving plates 35a and 35b are integrally mounted by screws 49.

A mirror charging cam portion 50 that charges a mirror charging spring 56, described later, for actuating the mirror 15 and a shutter charging gear portion 51 for charging a shutter charging spring 65, described later, that drives the shutter blades 25a, 25b, 25c and 25d are integrally provided on the sixth gear 47 of the charger 14b.

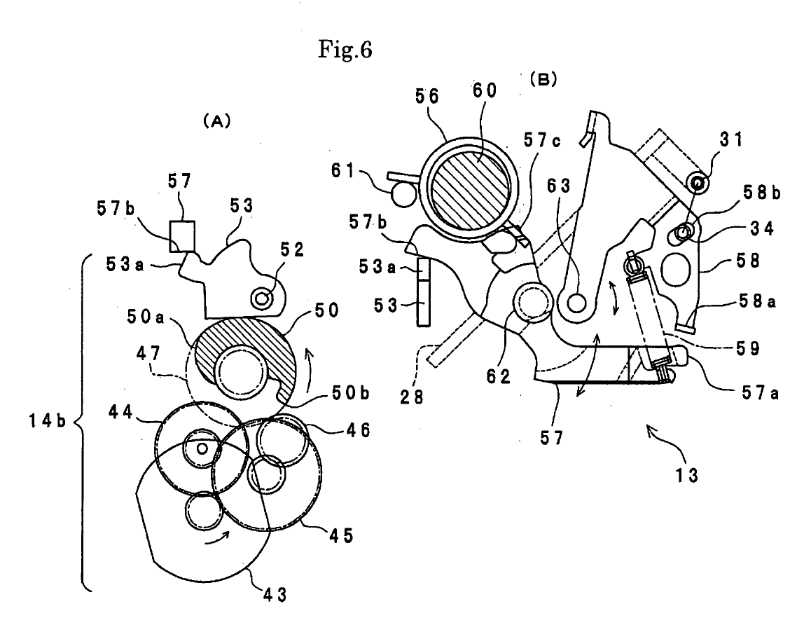

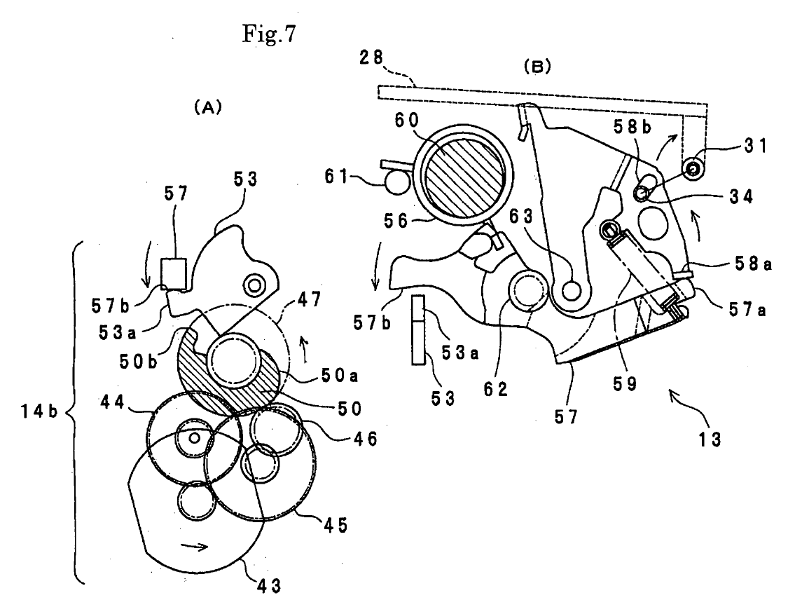

A mirror charging lever 53 pushed counterclockwise around a spindle 52 abuts on the mirror charging cam portion 50 of the sixth gear 47 as shown in FIGS. 6(A) and 7(A), the mirror charging lever 53 is rotated clockwise by a cam surface 50a, and when a cam end 50b is exceeded, the mirror charging lever 53 is rotated counterclockwise. A protrusion 53a abutting on an abutment portion 57b of a first mirror driving lever 57, described later, of the mirror driver 13 is formed on the mirror charging lever 53.

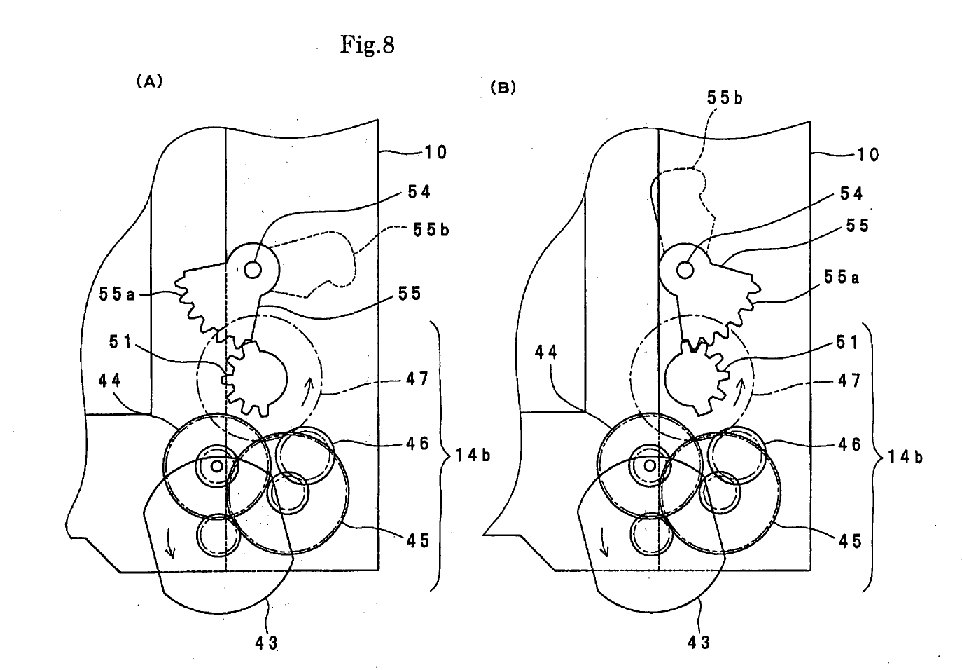

The shutter charging gear portion 51 of the sixth gear 47 meshes with a gear portion 55a formed at one end of a shutter charging lever 55 pushed counterclockwise about a spindle 54 by non-illustrated pushing member as shown in FIGS. 8(A) and 8(B), and the shutter charging lever 55 is rotated clockwise. When the shutter charging gear portion 51 is unmeshed from the gear portion 55a of the shutter charging lever 55, the shutter charging lever 55 is rotated counterclockwise. An abutment portion 55b abutting on a cam portion 64c of the shutter driving lever 64, described later, of the shutter driver 12 is formed on the shutter charging lever 55.

<Mirror Driver>

The mirror driver 13 comprises the first mirror charging spring 56, the first mirror driving lever 57, a second mirror driving lever 58 and a second mirror charging spring 59 as shown in FIGS. 6(B) and 7(B). The first mirror charging spring 56 is held by a protrusion 60 of the frame member 6, and one end thereof is restricted by a protrusion 61 of the frame member 6 and the other end thereof is restricted by the first mirror driving lever 57. The first mirror driving lever 57 is provided on the frame member 6 so as to be rotatable about a spindle 62, and an abutment portion 57a abutting on a protrusion 58a of the second mirror driving lever 58 is formed at one end thereof. The abutment portion 57b on which the protrusion 53a of the mirror charging lever 53 abuts and a restrictor 57c that restricts the other end of the first mirror charging spring 56 are formed at the other end of the first mirror driving lever 57. The second mirror driving lever 58 is provided on the frame member 6 so as to be rotatable about a spindle 63, and the protrusion 58a on which the abutment portion 57a of the first mirror driving lever 57 abuts and a cam hole 58b in which the driving shaft 34 of the main mirror holder 30 is inserted are formed at one end thereof. The second mirror charging spring 59 is coupled between the first mirror driving lever 57 and the second mirror driving lever 58.

<Charging/Running of the Mirror>

When the charging motor 43 of the charger 14b of the driving unit 14 is driven, the sixth gear 47 is rotated counterclockwise, and the mirror charging lever 53 is rotated clockwise by the cam surface 50a of the mirror charging cam portion 50 formed on the sixth gear 47. The protrusion 53a of the mirror charging lever 53 rotates the first mirror driving lever 57 of the mirror driver 13 clockwise. This charges the first mirror charging spring 56. The rotation of the first mirror driving lever 57 is transmitted to the second mirror driving lever 58 through the second mirror charging spring 59, so that the second mirror driving lever 58 is rotated clockwise. Consequently, the cam hole 58b of the second mirror driving lever 58 rotates the main mirror holder 30 counterclockwise through the driving shaft 34 to bring about the charging completion condition of FIG. 6(B).

When the sixth gear 47 is further rotated counterclockwise to thereby detach the mirror charging lever 53 from the cam end 50b of the mirror charging cam portion 50, the first mirror driving lever 57 is rotated counterclockwise by the spring force charged on the first mirror charging spring 56. Then, the abutment portion 57a of the first mirror driving lever 57 abuts on the protrusion 58a of the second mirror driving lever 58, so that the second mirror driving lever 58 is rotated counterclockwise. Consequently, the cam hole 58b of the second mirror driving lever 58 causes the main mirror holder 30 to run clockwise through the driving shaft 34 to bring about the running completion condition of FIG. 7(B).

<Shutter Driver>

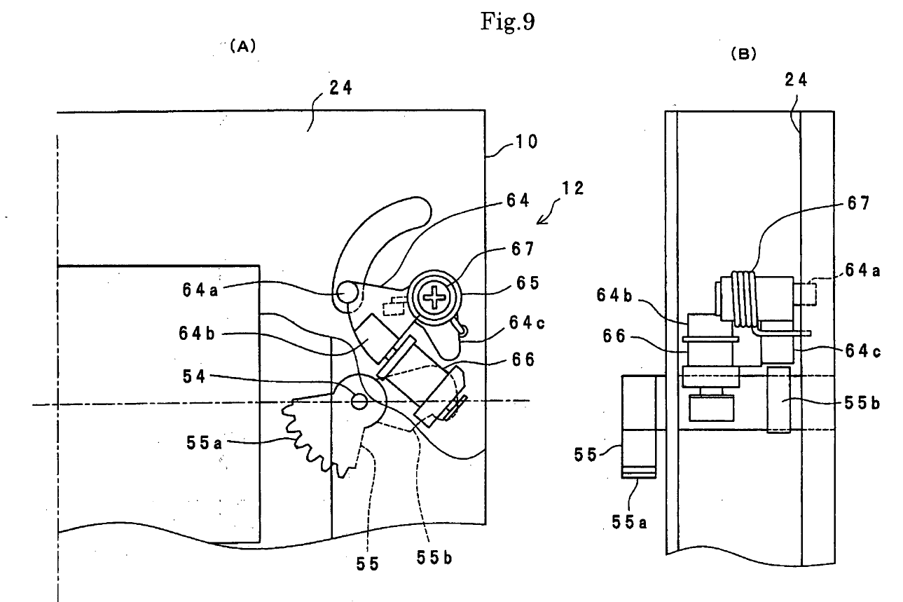

The shutter driver 12 comprises, as shown in FIGS. 9(A) and 9(B), the shutter driving lever 64, the shutter charging spring 65 and an electromagnet 66. The shutter driving lever 64 is attached to the shutter base plate 24 so as to be rotatable about a spindle 67, and is provided with a cam pin 64a fitted in the cam hole 27 of the shutter blade 25a of FIGS. 4(A) and 4(B) and an adherence portion 64b. Moreover, a cam portion 64c is integrally formed on the shutter driving lever 64. The shutter charging spring 65 is held by the spindle 67 of the shutter driving lever 64, and one end thereof is restricted by the shutter base plate 24 and the other end thereof is restricted by the shutter driving lever 64. The electromagnet 66 is attached to the shutter base plate 24 so that the adherence portion 64b held on the shutter driving lever 64 is adherable to the adherent surface thereof.

<Charging/Running of the Shutter>

In FIGS. 8(A) and 8(B), when the charging motor 43 of the charger 14b of the driving unit 14 is driven to rotate the sixth gear 47 counterclockwise, the shutter charging lever 55 is rotated clockwise by the shutter charging gear portion 51 formed on the sixth gear 47. The abutment portion 55b of the shutter charging lever 55 abuts on the cam portion 64c of the shutter driving lever 64 as shown in FIGS. 9(A) and 9(B) to rotate the shutter driving lever 64 counterclockwise. This charges the shutter charging spring 65. The cam pin 64a of the shutter driving lever 64 presses the cam hole 27 of the shutter blade 25a. Consequently, all of the shutter blades 25a to 25b are moved through the link members 26a to 26c and the exposure window 23 of the shutter base plate 24 is closed to bring about the charging completion condition of FIG. 4(A). At this time, the electromagnetic 66 is energized and causes the adherence portion 64b held on the shutter driving lever 64 to adhere thereto, whereby the charging completion condition is maintained.

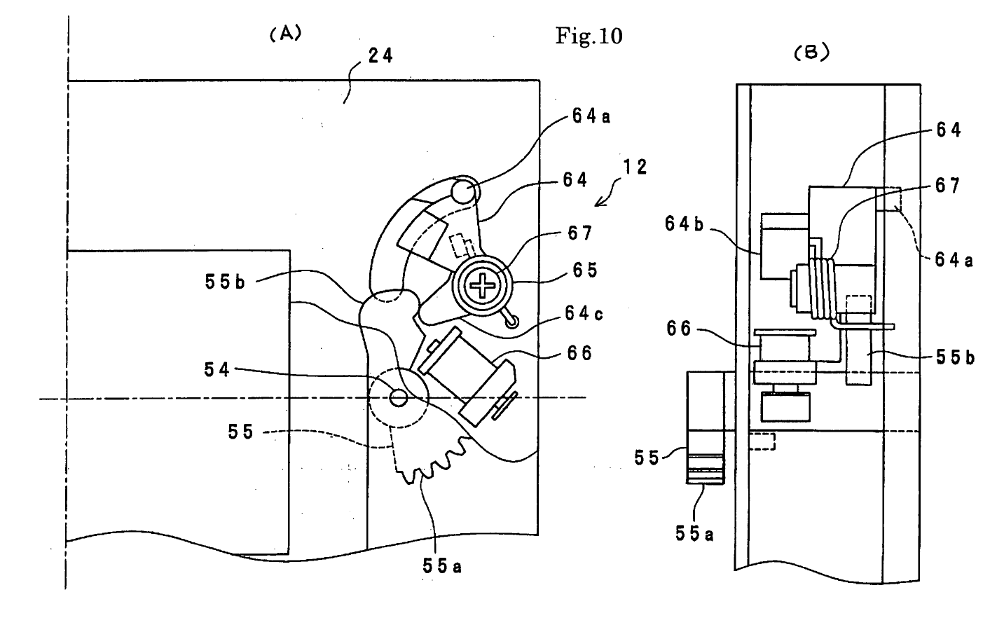

When the sixth gear 47 further rotates counterclockwise, the shutter charging gear portion 51 is unmeshed from the gear portion 55a of the shutter charging lever 55. When the electromagnet 66 is de-energized, the shutter driving lever 64 is rotated clockwise by the spring force charged on the shutter charging spring 65 as shown in FIG. 10. Consequently, the cam pin 64a of the shutter driving lever 64 presses the cam hole 27 of the shutter blade 25a and the shutter blades 25a to 25d are caused to run to bring about the running completion condition of FIG. 4(B). In this embodiment, the shutter blades 25a to 25d run only in the opening direction, and the exposure is ended by ending the charge accumulation by the image sensor 11.

As described above, the driving of the shutter blades 25a to 25d uses, as the driving source, the restoring force of the shutter charging spring 65 charged by the two levers, the shutter charging lever 55 and the shutter driving lever 64, and is extremely simple in structure. Since the driving source of the charging of the mirror charging springs 56 and 59 is used as the driving source of the charging of the shutter charging spring 65, a dedicated driving source is unnecessary for the charging of the shutter charging spring 65, so that simple and inexpensive driving means is achieved. Moreover, although the disposition of the shutter driver 12 which is larger in the size in the direction of the taking optical path than the shutter body 10 is a problem, this is solved by disposing the shutter driver 12 on the right side of the taking optical path like in the above-described embodiment.

<Insertion and Detachment Structure of the Shutter Unit and the Driving Unit>

Next, the structure for inserting and detaching the shutter body 10, the shutter driver 12 and the driving unit 14 of the camera of the above-described embodiment into and from the camera body will be described. Here, a unit comprising the shutter body 10 and the shutter driver 12 attached to the shutter body 10 will be referred to as a shutter unit 10, 12.

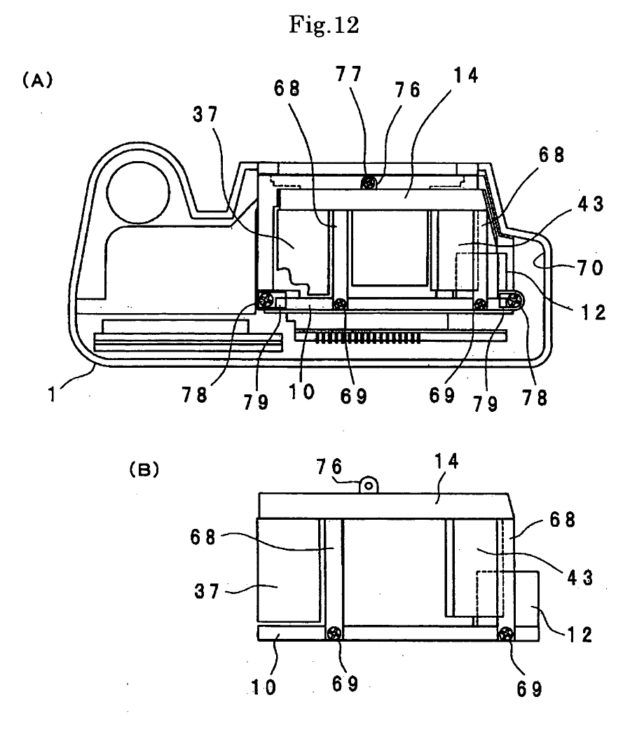

The shutter unit 10, 12 and the driving unit 14 are coupled together by a holding frame 68 as shown in FIGS. 12(A) and 12(B), and integrally fixed as a shutter block by fastening screws 69. While the components of the shutter block are the shutter unit 10, 12 and the driving unit 14 in the present embodiment, they may be the shutter unit 10, 12 and at least one of the focus driver 14a and the charger 14b of the driving unit 14, the focus motor 37 and the charging motor 43.

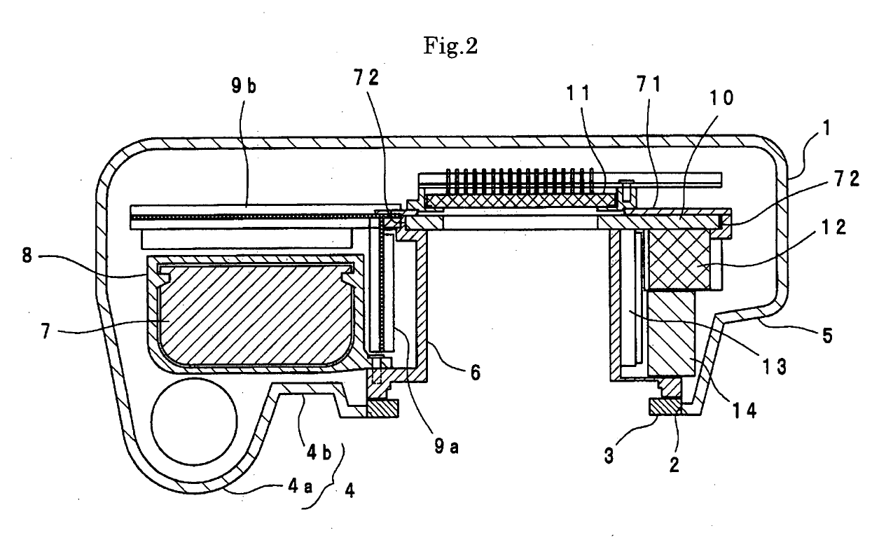

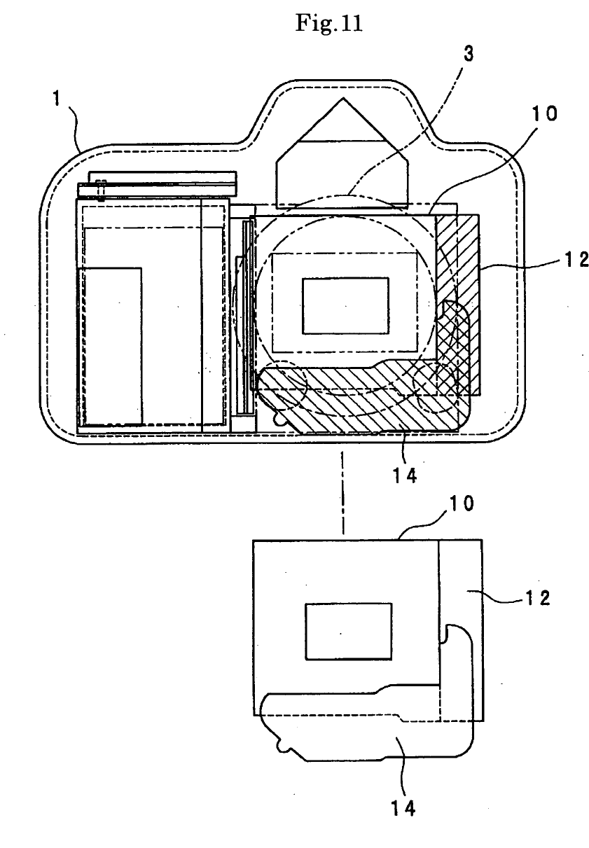

The shutter unit 10, 12 and the driving unit 14 can be inserted into the camera body 1 and detached from the camera body 1 through an opening 70 at the bottom of the camera body 1 in the vertical direction which is the direction of a first axis within a plane orthogonal to the optical axis as shown in FIG. 11. The front surface of the shutter body 10 of the shutter unit 10, 12 is guided by the rear end surface of the frame member 6 as shown in FIG. 2, and the rear surface thereof is guided by a shutter holding plate 71. The rear end surface of the frame member 6 and the shutter holding plate 71 restrict the movement of the shutter body 10 in the direction of the optical axis. The right and left ends of the shutter body 10 are guided by a restrictor 72 formed on the frame member 6. The restrictor 72 restricts the movement of the shutter body 10 in the direction of a second axis perpendicular to the direction of the first axis within the plane orthogonal to the optical axis. The upper end of the shutter body 10 is restricted by a restrictor 73 formed on the frame member 6 as shown in FIGS. 3(A) and 3(B). The restrictor 73 restricts the insertion position, in the direction of the first axis, of the shutter body 10.

The driving unit 14 is positioned by inserting a boss 74 at the upper end of the driving plate 35b into a hole 75 formed on the bottom surface of the frame member 6 as shown in FIGS. 3(A) and 3(B). Moreover, in the shutter unit 10, 12 and the driving unit 14, as shown in FIG. 12(A), a protrusion 76 provided on the driving plate 35a of the driving unit 14 is fixed by a cap screw 77, and both ends of the shutter body 10 are fixed to the frame member 6 by presser metal members 79 provided so as to be rotatable and fixable by screws 78. By attaching the cap screw 77 and the presser metal members 79, the shutter unit 10, 12 and the driving unit 14 can be prevented from falling out of the camera body 1, and can be detached from the camera body 1 by detaching them. After replacement is finished, a non-illustrated lower exterior member is attached to the bottom of the camera to finish the work.

The shutter unit 10, 12 and the driving unit 14 are principal parts that perform dynamic operations every time image taking is performed, and their endurance affects the mechanical life of the camera. In the above-described embodiment, since the shutter unit 10, 12 and the driving unit 14 are integrally formed as a shutter block, the replacement workability from the bottom of the camera body 1 is excellent as shown in FIG. 11.

Moreover, the precision of the distance, in the direction of the optical axis, and the relative inclination between the mount 3 which is the boundary with the interchangeable lens and the image sensor 11 affects the focus performance of the camera. In the above-described embodiment, since it is unnecessary to detach the mount 3 or the image sensor 11 when the shutter unit 10, 12 and the driving unit 14 are replaced or inspected, the distance and the relative inclination between the mount 3 and the image sensor 3 are never changed. Consequently, it is unnecessary to perform focus adjustment or the like after the replacement or the inspection of the shutter unit 10, 12 and the driving unit 14.

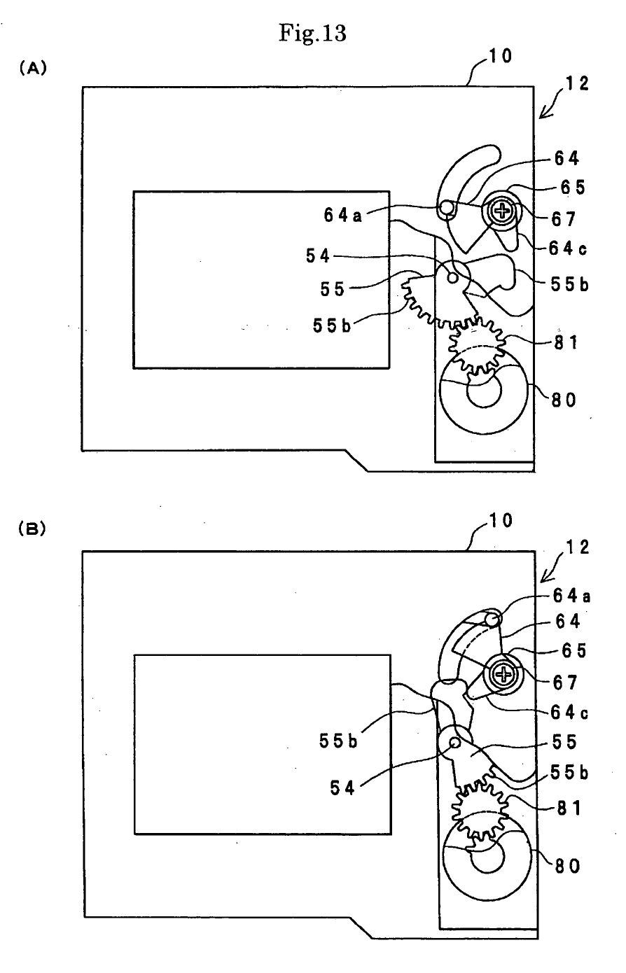

In the above-described embodiment, the driving source of the charging the shutter charging spring 65 of the shutter driver 12 is the same as the driving source of the charging of the mirror charging springs 56 and 59 of the mirror driver 13. However, the present invention is not limited thereto. As shown in FIGS. 13(A) and 13(B), an independent shutter charging motor 80 and intermediate gear 81 for charging the shutter charging spring 65 of the shutter driver 12 may be provided in the shutter driver 12. In this case, the body can also be made compact by disposing the shutter driver 12 on the right side of the taking optical path. Moreover, since the driving unit 14 does not require the shutter charging portion 51, there is no restriction on the disposition and the degree of freedom is high.

Moreover, while in the above-described embodiment, the shutter is of a type in which the shutter blades 25a to 25d run upward to open the exposure window 23, the running direction of the shutter blades is not limited thereto. Moreover, even when a shutter comprising a front blade and a rear blade is used, the body can be made compact by disposing the shutter driver thereof on the right side of the taking optical path.

Moreover, while the above-described embodiment is a lens-interchangeable camera, the same applies to lens-noninterchangeable cameras.

Although the present invention has been fully described by way of examples with reference to the accompanying drawings, it is to be noted that various change and modifications will be apparent to those skilled in the art. Therefore, unless otherwise such changes and modifications depart from the scope of the present invention, they should be construed as being including therein.

1. An image taking apparatus comprising:
an image taking lens;
an image sensor for capturing a subject image by the image taking lens; and
a shutter block that is situated between the optical lens and the image sensor and is movable between a first position in which a taking luminous flux from the lens is intercepted within a plane orthogonal to an optical axis of the lens and a second position in which the taking luminous flux from the lens is transmitted to the image sensor,
wherein the shutter block is held so as to be insertable and detachable within the plane orthogonal to the optical axis.

2. An image taking apparatus according to claim 1, wherein the insertion and detachment direction of the shutter block is a vertical direction of the image taking apparatus.

3. An image taking apparatus according to claim 2, wherein the shutter block is insertable and detachable from a bottom of the image taking apparatus.

4. An image taking apparatus according to claim 1, wherein the shutter block is insertable and detachable in a direction of a first axis within the plane orthogonal to the optical axis, and the image taking apparatus further comprises:
a first shutter restrictor for restricting a movement of the shutter block in a direction of the optical axis;
a second shutter restrictor for restricting the movement of the shutter block in a direction of a second axis orthogonal to the direction of the first axis within the plane orthogonal to the optical axis;
a third shutter restrictor for restricting an insertion position, in the direction of the first axis, of the shutter block; and
a presser for preventing the shutter block from falling out in the direction of the first axis.

5. An image taking apparatus according to claim 1, wherein the shutter block includes a shutter blade and a first driver for moving the shutter blade from the first position to the second position.

6. An image taking apparatus according to claim 5, wherein the shutter block further includes a second driver for moving the shutter blade from the second position to the first position.

7. An image taking apparatus according to claim 1, further comprises a focus driver for performing focus adjustment by driving the image taking lens in the direction of the optical axis, and
wherein the shutter block integrally holds the focus driver.

8. An image taking apparatus according to claim 1, further comprises a mirror that is held so as to be movable between a first position situated within the taking optical path and reflecting the taking luminous flux and a second position retracted from the taking optical path and directing the taking luminous flux to the image sensor; and
a mirror driver for driving the mirror between the first position and the second position, and
wherein the shutter block integrally holds the mirror driver.

9. An image taking apparatus according to claim 1, wherein the shutter block has a driver including at least one motor that performs a driving that is different from the driving of the shutter blade, and integrally holds the driver.

10. An image taking apparatus according to claim 9, wherein the driver has a motor for charging a shutter blade.

11. An image taking apparatus according to claim 1, wherein the image sensor is a photoelectric conversion element.

12. An image taking apparatus according to claim 1, wherein the image sensor is silver halide film.

13. A shutter unit used for an image taking apparatus has an image taking lens and an image sensor for capturing a subject image by the image taking lens, comprising:
a shutter blade; and
a shutter driver for driving the shutter blade,
wherein the shutter unit that is situated between the optical lens and the image sensor and is movable between a first position in which a taking luminous flux from the lens is intercepted within a plane orthogonal to an optical axis of the lens and a second position in which the taking luminous flux from the lens is transmitted to the image sensor, and
wherein the shutter unit is held so as to be insertable and detachable within the plane orthogonal to the optical axis.

14. A shutter unit according to claim 13, further comprises a focus driver for driving the image taking lens.

15. A shutter unit according to claim 13, further comprises a mirror driver for driving a mirror of the image taking apparatus.
